(19) United States
(12) Patent Application Publication
(10) Pub. No.: US 2004/0225736 A1
(43) Pub. Date: Nov. 11, 2004

(54) Method and apparatus for providing a dynamic quality of service for serving file/block I/O

(76) Inventor: Roger C. Raphael, Sunyvale, CA (US)

Correspondence Address: KUNZLER & ASSOCIATES, 8 EAST BROADWAY, SUITE 600, SALT LAKE CITY, UT, 84111, US

(21) Appl. No.: 10/430,554

(22) Filed: May 6, 2003

(51) Int. Cl. G06F 15/173

(52) U.S. Cl. 709/226

(57) ABSTRACT

A method and apparatus are provided for dynamically improving the quality of service in a file or block serving system through assessing initial service quality, altering the service grade or priority of a selected resource handle, assessing a modified service quality impacted by that alteration of the resource handle service grade, and adjusting the resource handle service grade in response to the modified service quality. Alteration of the service grade may be achieved through intentionally imposing latency on the transactions associated with the selected resource handle. Alternately, the service grade alteration may result from randomly changing the priority ranking or service priority of the selected resource handle, thereby impacting the processing of the I/O transactions. The method and apparatus may be implemented at the back, or service end, of the system within the data storage sub-system, independent from and transparent to host and network awareness.

### BACKGROUND OF THE INVENTION

1. The Field of the Invention

The invention relates to the field of file server service quality and more particularly to improving service quality through dynamic creation and administration of multiple request processing service queues in response to an assessment of the system performance under normal and altered operating conditions, where each queue corresponds to a service grade.

2. The Relevant Art

Quality of service is a computer system attribute relating to I/O processing of the system. The processing includes I/O requests and data transfers within or processed by the system in a given time period. Quality of service is a well-established, advanced feature used in the computer networking and telecommunications industry to enhance the productivity and efficiency of large storage systems. Quality of service is implemented to enable and improve the overall expected and deliverable service levels to a multitude of consumers on the front end of the system.

As processors and storage media are produced with increasing speed and volume capacities, it is critical that data access time is minimized so as to improve efficiency and performance of the large external system. Consequently, quality of service in a data storage sub-system has become a major focus in file and block server systems.

Most file and block server systems employ a cache and cache management system in order to maintain ready access to frequently used files, blocks, and even entire disks. Cache is a storage medium or portion thereof that is typically employed to offer very fast access to data for transfer or processing. Recently and/or frequently accessed files may be stored locally on the accessible cache in addition to being stored on a secondary storage medium within the data storage sub-system that has a slower associated access time.

The relatively fast access times using cache compared to data storage sub-systems, such as a redundant array of independent disks (RAID) system, provides for significantly improved system performance. However, cache size is greatly limited by the cost of additional cache memory and the upgrade installation time. Consequently, many manufacturers and end users have implemented, in addition to cache memory and cache memory management, a variety of strategies to decrease access time to a data storage sub-system directly.

One such strategy focuses on bandwidth allocation. Bandwidth allocation may be implemented at the data storage sub-system level by imposing a hierarchical file organization. The hierarchical file organization is arranged to allow the bandwidth allocation for media storage devices to be balanced when a data file is sequentially accessed. Bandwidth allocation may also be implemented at the client level through storage device assignments corresponding to each client. The objective of such bandwidth allocation is to eliminate any system bottlenecks that may exist.

The relevant art also currently uses access probability and frequency tracking to decrease access time to a data storage sub-system. Tracking the frequency of a file access allows a system to manipulate such tracking statistics to attempt to predict the probability of future file accesses. A request for a file access that has a higher predicted probability may be provided with greater bandwidth or faster access by maintaining a copy on a local cache.

However, such frequency tracking does not afford a direct and exclusive correlation with the quality of service of the system. For example, a frequently accessed file may be allocated valuable bandwidth or cache regardless of what impact such file access might have on the system as a whole. A frequently accessed file that has little impact on the system performance might be given a higher priority than a seldom accessed file that, when accessed, may substantially degrade performance generally throughout the system. Consequently, the bandwidth and cache allocation, in this manner, do not necessarily provide any increase in system performance.

An additional strategy tracks file access frequency in a manner similar to that described above. The tracking statistics may be used to create a copy of large, frequently accessed files. Such copying may be performed during off-peak system time in order to limit any possible negative impact on the system performance. Nevertheless, off-peak downloading does not alleviate resource demands at the time of the original file access. Furthermore, off-peak downloading does not provide any quality of service for infrequently accessed real-time applications.

It would be advantageous to provide a method and apparatus for improving quality of service within a file or block serving system such that data accesses are processed based on a corresponding service grade for such data transactions. The service grade could be dependent upon the overall impact that the data access has on the system. For example, a higher service grade and increased processing priority would be accorded to an I/O request that, if not processed quickly, could greatly degrade overall system performance. Similarly, a lower service grade and decreased processing priority would be accorded to an I/O request that does not impact the system performance, or impacts it very little.

It would also be advantageous for such a method and apparatus to be implemented at the back, or service end, of the system such that all of the operations for improving service quality in the system originate from and are processed within the data storage sub-system. In this manner, the method and apparatus may have a lower total cost of implementation and be transparent to a legacy host so that the host may continue processing as normal, without added functionality requirements, while yet improving the service quality of the entire system.

### BRIEF SUMMARY OF THE INVENTION

The present invention has been developed in response to the present state of the art, and in particular, in response to the problems and needs in the art that have not yet been fully solved by currently available quality of service means and methods. Accordingly, the present invention has been developed to provide a system, apparatus, and method for dynamic service quality in a file or block serving systems that overcome many or all of the above-discussed shortcomings in the art. The system, apparatus, and method provided are configured to determine a priority relationship among resource handles, which are essentially part of the existing meta data information of any file or block server, and to enable and dynamically improve service quality in either a file serving system or a block serving system. In the discussion that follows, reference to files and blocks and their respective systems should be understood as referring to either of the system types and not exclusive of one type over the other.

The apparatus for dynamic service quality for file or block serving I/O is provided with a logic unit containing a plurality of modules configured to carry out the individual steps of the detection and identification process. These modules in the described embodiments include an alteration module, an assessment module, an adjustment module, a priority alteration module, a latency alteration module, an arrival rate module, a priority adjustment module, a service queue module, an initialization module, a persistence module, and a selection module.

In one embodiment, an apparatus and the aforementioned modules are configured to alter the service grade associated with a selected file or block resource handle. The apparatus is further configured to assess both initial and modified service qualities for the system. Using the assessment statistics gathered and stored in appropriate record files, the apparatus may adjust the service grade for the selected resource so as to improve the service quality for the overall system.

The service grade may be altered, in one embodiment, through imposing otherwise unnecessary latency on I/O request transactions associated with the selected resource and, in a further embodiment, through alteration of a service priority designation associated with the selected resource.

The assessment of the system service quality may be performed by a rate probe or a QoS (quality of service) probe. The rate probe is configured to assess the service quality of the system under normal operating conditions. The rate probe specifically tracks the arrival rates (number of access requests over a specified period of time) for active file or block handles. The QoS probe, on the other hand, is configured to asses the system service quality under altered conditions, either through imposed latency or altered priority, as mentioned above. In a manner similar to the rate probe, the QoS probe also tracks the arrival rates of active handles, but does so during the period of altered conditions.

Using the periodically triggered rate probe and QoS probe assessments, the apparatus is configured to dynamically create or remove a plurality of request processing queues corresponding to the designated resource handle service grades. The presence of such queues allows the I/O transactions to be processed in a manner that fills higher priority requests as required to maintain the most efficient use of system resources. In general, the I/O processing may assign priority levels in two ways. First, a handle may be assigned a priority level corresponding to an existing processing queue. Second, a handle may be processed in a newly materialized queue corresponding to the priority level of one or more handles of a specified service grade.

A method of the present invention is also presented for providing a dynamic service quality for file or block serving I/O. The method in the disclosed embodiments substantially includes the steps presented above with respect to the operation of the apparatus.

More specifically, the method initializes with an appropriate implementation of any default or operator-specified inputs and the setup of any necessary records used in the service quality process. After initialization, the method assesses the service quality of the system using one or more rate probes to establish a base measurement for comparison purposes. In one embodiment, such assessment is performed via a rate probe process in which the system tracks I/O arrival rates over a period of time to establish the base arrival rate for active resource handles.

Once the initial system service quality has been assessed, the method intentionally and temporarily alters the service grade of a specific candidate resource handle. Subsequently, all I/O transactions associated with the candidate resource handle are effectively slowed down and possibly impact the system performance. For example, the method may impose latency on the transactions of the candidate resource handle. Under these altered conditions, the method might use a QoS probe to assess the modified arrival rates of the active resource handles.

After assessing the service quality of the system under these altered conditions, the method then determines if the priority level of the selected resource handle should be altered. For example, if adding latency to the transactions of the selected resource handle decreased the arrival rates of the active resource handles, then the selected resource handle may be assigned a higher priority level because of the significant impact it may have on the system. Alternately, the selected resource may be assigned a lower priority if no impact or very little impact is observed. Ultimately, if no impact is determined to take place, the selected resource handle may maintain its existing service priority level. The method allows the system to dynamically adjust the service grade of the selected resource accordingly.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of a representative file server system in accordance with the prior art;

FIG. 2 is a schematic block diagram illustrating one embodiment of a representative data storage sub-system in accordance with the prior art;

FIG. 3 is a schematic block diagram illustrating one embodiment of a representative data storage sub-system in accordance with the present invention;

FIG. 4 is a schematic block diagram illustrating one embodiment of a representative optimization module of FIG. 3 for improving service quality in a data storage system in accordance with the present invention;

FIG. 5 is a schematic block diagram illustrating one embodiment of a representative electronic storage device in accordance with the present invention;

FIG. 5a is a schematic block diagram illustrating one embodiment of a representative rate probe transaction record in accordance with the present invention;

FIG. 5b is a schematic block diagram illustrating one embodiment of a representative QoS probe transaction record in accordance with the present invention;

FIG. 5c is a schematic block diagram illustrating one embodiment of a representative master record in accordance with the present invention;

FIG. 5d is a schematic block diagram illustrating one embodiment of a representative rate history record in accordance with the present invention;

FIG. 5e is a schematic block diagram illustrating one embodiment of a representative QoS tally record in accordance with the present invention;

FIG. 6 is a schematic block diagram illustrating one embodiment of a representative I/O request handle instance in accordance with the present invention;

FIG. 7 is a schematic flow chart diagram illustrating one embodiment of a representative dynamic service quality method for file or block serving I/O in accordance with the present invention;

FIG. 8 is a schematic flow chart diagram illustrating one embodiment of a representative initialization method in accordance with the present invention;

FIG. 9 is a schematic flow chart diagram illustrating one embodiment of a representative service quality assessment method in accordance with the present invention;

FIG. 9a is a schematic flow chart diagram illustrating one embodiment of a representative I/O process during a service quality assessment method in accordance with the present invention;

FIG. 9b is a schematic flow chart diagram illustrating one embodiment of a representative receiver process during a service quality assessment method in accordance with the present invention;

FIG. 10 is a schematic flow chart diagram illustrating one embodiment of a representative service grade alteration method in accordance with the present invention;

FIG. 10a is a schematic flow chart diagram illustrating one embodiment of a representative I/O process during a service grade alteration method in accordance with the present invention;

FIG. 10b is a schematic flow chart diagram illustrating one embodiment of a representative receiver process during a service grade alteration method in accordance with the present invention;

FIG. 11 is a schematic flow chart diagram illustrating one embodiment of a representative service quality change assessment method in accordance with the present invention; and

FIG. 12 is a schematic flow chart diagram illustrating one embodiment of a representative service grade adjustment method in accordance with the present invention.

### DETAILED DESCRIPTION OF THE PREFERRED EMBODIMENTS

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the discussion that follows, any reference to files and blocks and their respective systems should be understood as referring to either of the system types and not exclusive of one type of data structure or system over the other.

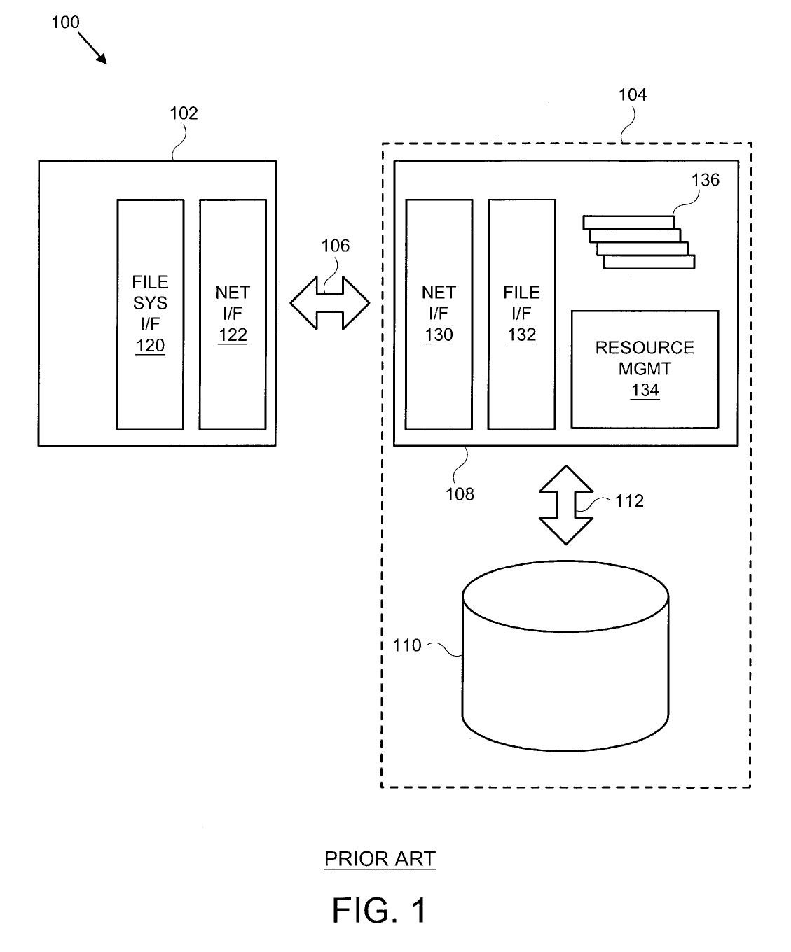

FIG. 1 depicts one embodiment of a representative file serving system 100 of the prior art, which is considered a suitable environment for employment of the present invention. The file serving system 100 includes a client 102 and a data storage sub-system 104 connected by a communications channel 106 which may comprise any suitable communication medium, but in one embodiment is a storage area network (SAN).

The client 102 includes a file system interface module 120 and a network interface module 122. These interfaces 120 and 122 are typical components in a client 102 and are employed to service the file read and write operations, as well as the communications interface over the communications channel 106.

The data storage sub-system 104 in the depicted embodiment includes a data storage server 108 and a set of electronic storage devices 110, such as block storage or reel storage. A communications channel 112 that may be similar to the communications channel 106 connects the server 108 and the storage device 110. The server 108 may be a file server or a block server as required by the type of system in which it is implemented.

Internal to the data storage server 108 are a network interface module 130 and a file interface module 132. These modules 130 and 132 are similar to modules 122 and 120, respectively, in that they are employed to service communications interface over the communications channel 112, as well as the file read and write operations. The data storage server 108 also preferably includes a resource management module 134 that manages the data transfer and processing internal to the server 108.

The server 108 also preferably includes one or more resource handles 136 that correspond to an equal number of file instances and associated meta data for each open file in a file server system. Similarly, the resource handles 136 may correspond to a logical unit number (LUN) instance and associated meta data for each open LUN in a block server system.

Even though the depicted embodiment shows a single client 102, multiple clients may be connected to a single server 108. In such an embodiment, the server 108 may be configured to perform LUN filtering across the multiple clients 102 in order to create subsets of LUNs or files that are associated with a specific client 102.

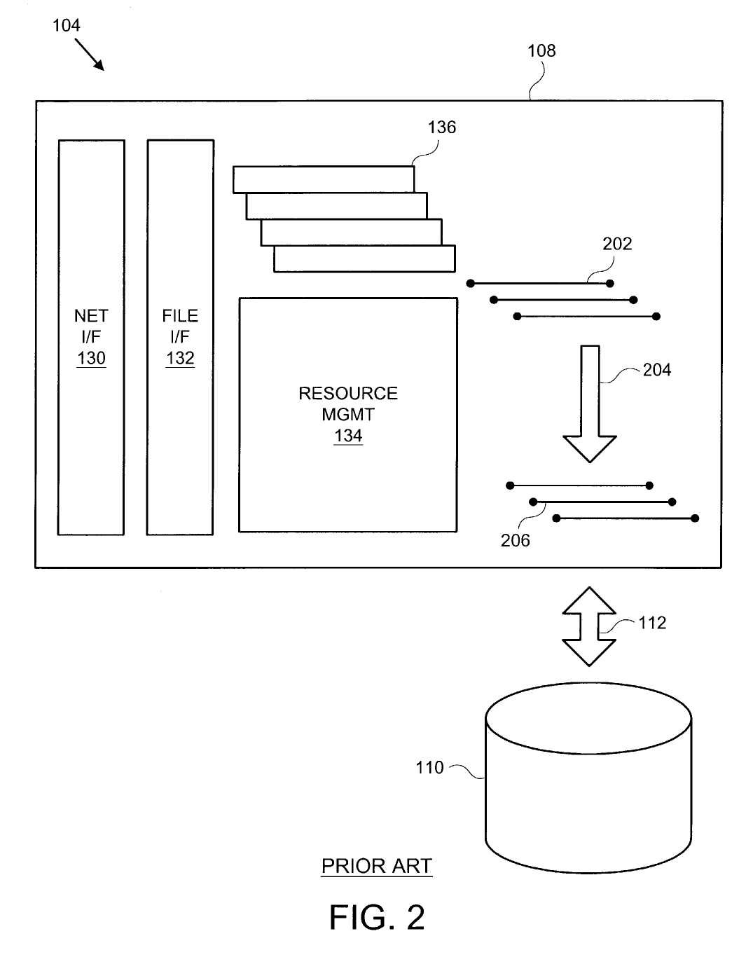

FIG. 2 presents more internal detail of the data storage subsystem 104 of FIG. 1. Specifically, FIG. 2 further illustrates a series of I/O request processes 202, a request processing queue 204, and a series of I/O processing and reply processes 206.

The illustrated I/O request processes 202 correspond to the file or block I/O request processes 202 received from the client 102. The received requests are associated with the resource handles 136 discussed previously. The I/O processing and reply processes 206 process the information presented by the I/O request processes 202 and reply to the requests made by the client 102. The request processing queue 204 represents the typical request enqueuing that occurs between the I/O request process 202 and the I/O processing and reply process 206.

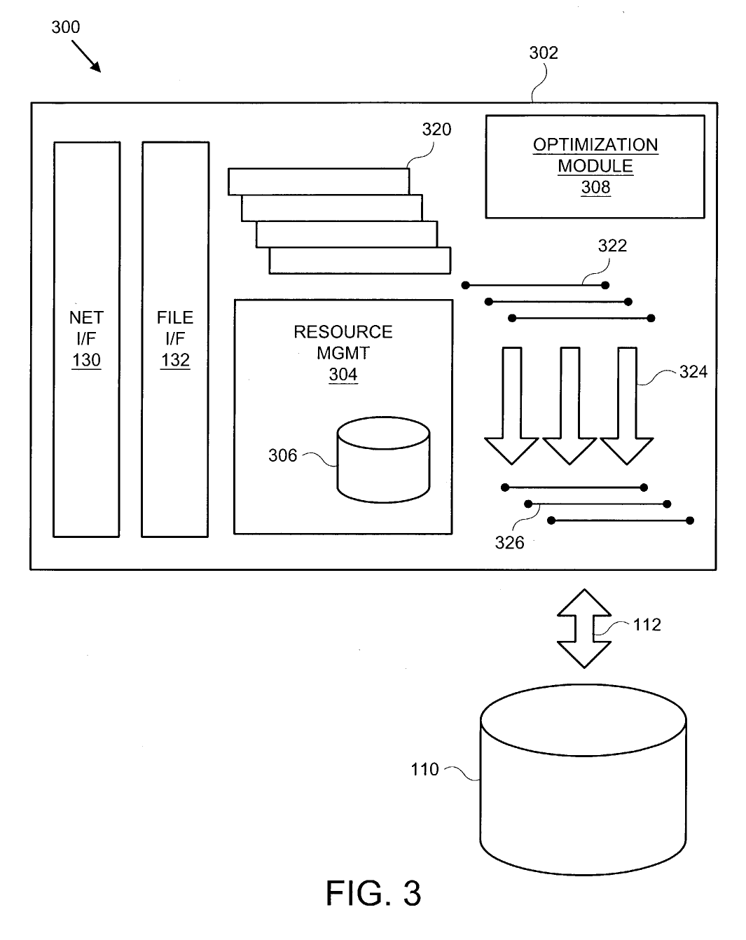

FIG. 3 illustrates one embodiment of a representative data storage subsystem 300 in accordance with the present invention. The subsystem 300 includes a data storage server 302 and an electronic storage device 110. The server 302 and the storage device 110 are connected by a communications channel 112. The server 302 may be a file server or a block server as required by the type of system in which it is implemented.

The server 302 in the depicted embodiment includes a network interface module 130 and a file interface module 132 that is preferably configured in a manner similar to the modules in the server 108. The server 302 also includes a resource management module 304 with a local electronic storage device 306, such as a random access memory (RAM). The storage device 306 serves as a local memory for the records and control instructions that are employed to provide a dynamic service quality in the file server system 100.

The server 302 also includes an optimization module 308 that contains the modules that in one embodiment provide the implementation for the dynamic service quality method and apparatus. The optimization module 308 may be independent from the resource management module 304, as shown, and may be partially or wholly integrated with the resource management module 304 in an alternate embodiment.

The data storage server 302 preferably administers processes in a manner similar to the data storage server 108, with the exception of certain differences outlined below. The server 302 is configured to receive I/O request processes 322 from the client 102. Such processes 322 are associated with resource handles 320 similar to the processes 202 and handles 136. The I/O processing and reply processes 326 administer the information presented by the I/O request processes 322 and reply to the requests made by the client 102. Accordingly, the processes 326 are similar to the threads 206.

The request processing queues 324 are preferably similar to the request processing queue 204. A very significant difference, however, between the implementation of the queues 324 and the queue 204 is the potential dynamic restructuring of the queues 324 in one embodiment that occurs in conjunction with the optimization module 308 and the resource management module 304. Such restructuring may happen in response to the initialization of a new service grade or removal of an inactive service grade, as discussed in conjunction with the method flow charts presented below.

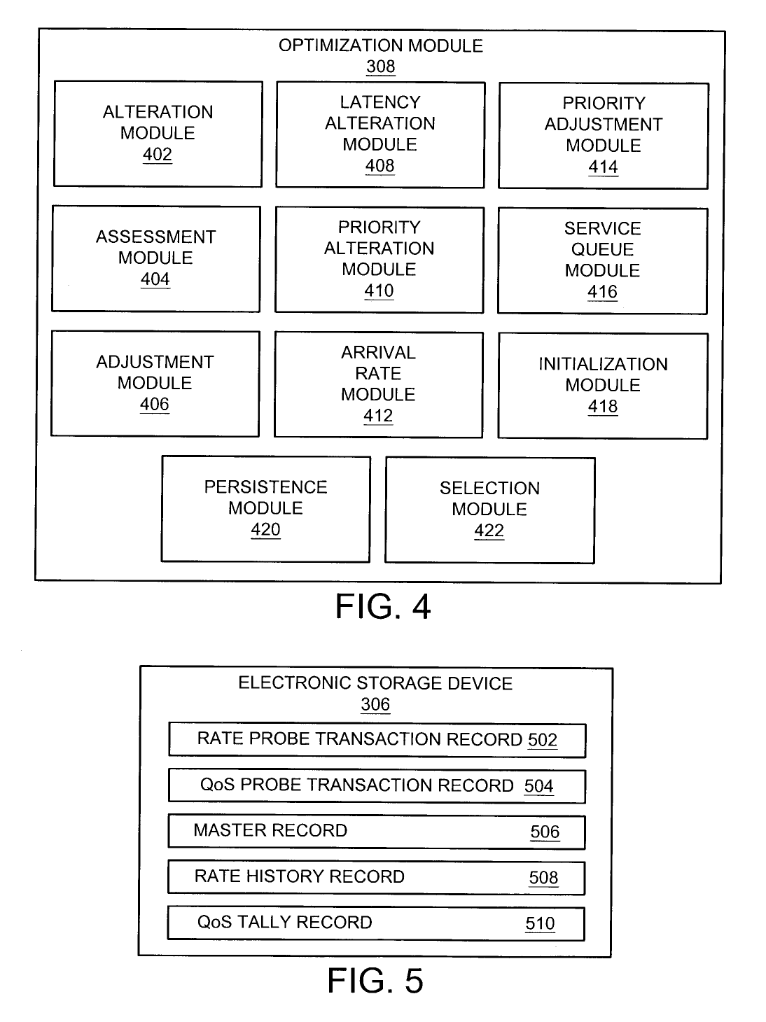

FIG. 4 depicts one embodiment of a representative optimization module 308 of the present invention. The optimization module 308, as illustrated, includes an alteration module 402, an assessment module 404, an adjustment module 406, a latency alteration module 408, a priority alteration module 410, an arrival rate module 412, a priority adjustment module 414, a service queue module 416, an initialization module 418, a persistence module 420, and a selection module 422.

The alteration module 402 is preferably configured to alter a service grade associated with a selected resource handle from the set of active resource handles 320. For example, a file handle from the set of active file handles 320 may be selected by the optimization module 308, and the alteration module 402 may be employed to alter the processing of the I/O transactions associated with the selected file handle 320.

In one embodiment, the alteration module 402 may implement a latency alteration on the I/O transactions that are processed by the data storage server 302 by intentionally imposing additional latency, via the latency alteration module 408. In an alternate embodiment, the alteration module 402 may intentionally alter the current service grade associated with the file handle 320, via the priority alteration module 410, thereby impacting the processing of the I/O transactions of all active file handles 320.

The assessment module 404 is in one embodiment configured to assess the service quality of the file serving system 100 and the data storage server 302. The service quality may refer to the transaction request arrival rates associated with processing of all client I/O transactions, in one instance, or alternately, may refer to the transaction request arrival rate associated with the client I/O transactions of a selected resource handle. In one embodiment, the assessment module 404 may employ the arrival rate module 412 in order to assess the I/O transaction request arrival rate of the system 100 or server 302.

The assessment module 404, in one embodiment, assesses an initial service quality of the system 100 as in a rate probe transaction and, in another embodiment, also assesses a modified service quality of the system 100 as in a QoS probe transaction. A modified service quality may result from an alteration of the service grade associated with a selected resource handle 320 as described in conjunction with the alteration module 402.

The assessment module 404 is also preferably configured to assess a change in the service quality of the file serving system 100 by comparing an initial service quality to a modified service quality. This may done by comparing service quality between data recorded in one or more rate probe transactions and one or more QoS probe transactions. The assessment module 404 may also assess the change in service quality by comparing a first modified service quality to a subsequent service quality of the system 100 or server 302. The assessment module 404 may also assess the change in service quality, taking into account all or some of the historical transactional records available to the server 302 at the time of assessment.

The adjustment module 406 is in one embodiment configured to adjust the service grade for a selected resource handle 320 in response to a change in the service quality of the file serving system 100 or data storage server 302. One manner in which the adjustment module 406 may adjust a service grade is through the priority adjustment module 414. The priority adjustment module 414 is preferably configured to change the priority assignment associated with a selected resource handle 320 as directed by the adjustment module 406.

The service queue module 416 as illustrated is configured to manage the materialization of the necessary request processing queues 324 as required by the dynamic service quality apparatus and method. The service queue module 416 preferably also manages, in conjunction with the resource management 304, the assignment of I/O request transactions to the appropriate queue 324 depending on the service grade associated with the corresponding resource handle 320.

The initialization module 418 is in one embodiment configured to initialize the dynamic service quality process, including establishing the necessary record files in the storage device 306 and loading any user settings that may affect the I/O transaction processing and dynamic service quality.

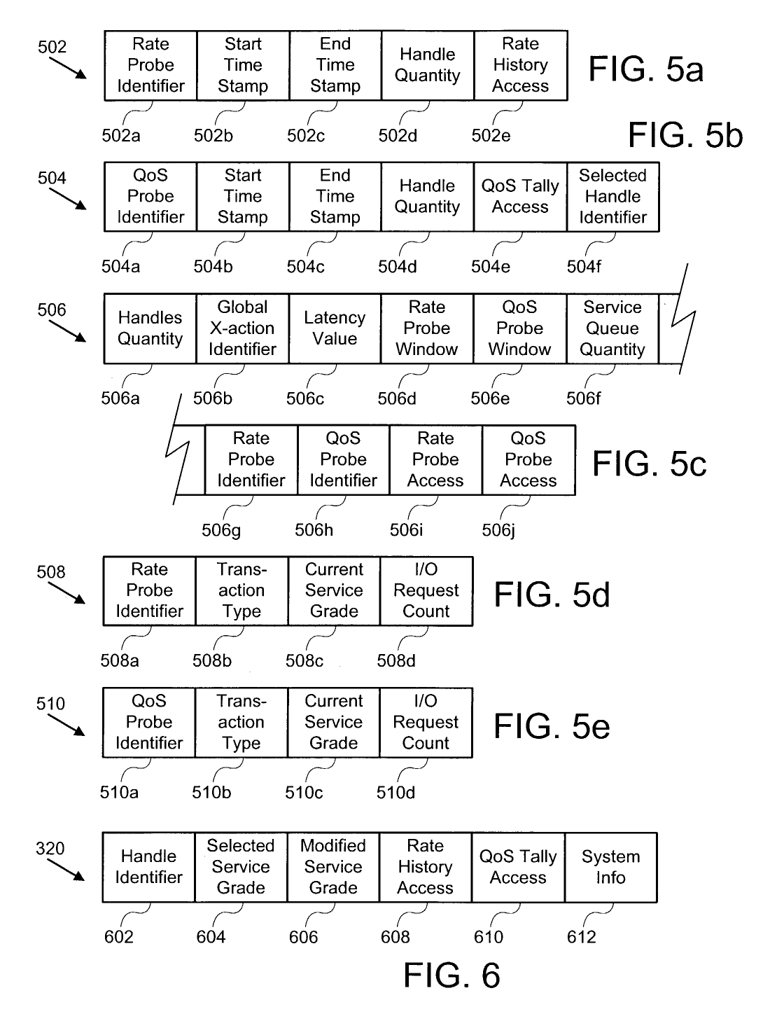

The persistence module 420 depicted is configured to allow the optimization module 308 to offload records from the local electronic storage device 306 to persistent storage, such as the electronic storage medium 110. Records that might be offloaded will be described further in conjunction with FIG. 5. One purpose of the persistence module 420 is to be able to accumulate sufficient records of QoS probe and rate probe transactions over time, given that the electronic storage device 306 may only be able to hold a limited number of active records at any point in time. The persistence module 420 may also provide startup history for the assessment module 404 at cold startup of the system 302.

The selection module 422 in one embodiment is configured to select between executing a rate probe transaction and a QoS probe transaction. As described above, a rate probe transaction establishes a history of typical request arrival rates under normal operating conditions of the server 302. A QoS probe transaction monitors the request arrival rates of the server 302 under a condition of imposed latency, in one embodiment, on the transactions associated with a particular resource handle 320. Certain embodiments of the rate and QoS probe transactions will be set forth in further detail in conjunction with the method flow chart diagrams presented below.

FIG. 5 depicts one embodiment of a representative electronic storage device 306. The electronic storage device 306 in the depicted embodiment includes several record files referenced for dynamic service quality in a file serving system 100. For example, the device 306 may contain a rate probe transaction record 502, a QoS probe transaction record 504, a master record 506, a rate history record 508, and a QoS tally record 510. The electronic storage device 306 may hold multiple hierarchies of such records constituting transactions that have happened over time in the server 302 depending on the capacity of the electronic storage device 306. These records 502, 504, 506, 508, 510 will be explained in further detail in the following figures.

FIG. 5a illustrates one embodiment of a representative data structure of a rate probe transaction record 502. A typical rate probe transaction record 502 may include a rate probe identifier field 502a, a start time stamp field 502b, an end time stamp field 502c, a handle quantity field 502d, and a rate history access link 502e. One rate probe transaction record 502 is created each time a rate probe assessment occurs. The data contained in one or more rate probe transaction records 502 may be accessed by the assessment module 404 in order to determine an initial or unaltered service quality that may be compared against a modified service quality.

The rate probe identifier field 502a in one embodiment identifies the current rate probe transaction number. The start time stamp field 502b and end time stamp field 502cpreferably track the duration of the rate probe. This duration is used in part to calculate the arrival rates of the I/O transactions associated with a specific resource handle 320. The handle quantity field 502d preferably stores the quantity of open resource handles 320 during the duration of the rate probe. The rate history access link 502e preferably points to a plurality of rate history records 508 that correspond to the open resource handles 320 for which an I/O transaction occurred during the rate probe transaction window.

FIG. 5b illustrates on embodiment of a representative data structure of a QoS probe transaction record 504. A typical QoS probe transaction record may include a QoS probe identifier field 504a, a start time stamp field 504b, an end time stamp field 504c, a handle quantity field 504d, a QoS tally access link 504e, and a selected handle identifier field 504f. In one embodiment, the QoS probe transaction record 504 may be configured to store data from a modified service quality assessment executed by the assessment module 404. One QoS probe transaction record 504 is created each time a QoS probe assessment occurs. The data contained in one or more QoS probe transaction records 504 may be accessed by the assessment module 404 in order to determine a modified service quality that may be compared against an initial or unaltered service quality derived from the rate probe assessment data. As stated above, the modified service quality refers to the system 100 performance that may result from the alteration of the service grade associated with a selected resource handle 320 from the set of active handles 320. The selected resource handle 320 for the QoS probe transaction is recorded in the selected handle identifier field 504f.

The QoS probe identifier field 504a in one embodiment identifies the current QoS probe transaction number. The start time stamp field 504b and end time stamp field 504cpreferably track the duration of the QoS probe. As with the rate probe transaction record 502, the duration of the QoS probe may be used to calculate the arrival rates of the I/O transactions associated with a specific resource handle 320 during the QoS probe assessment. The handle quantity field 504d may store the quantity of open resource handles 320 during the duration of the QoS probe. The QoS tally access link 504e preferably points to a plurality of QoS tally records 510 that correspond to the open resource handles 320 for which an I/O transaction occurred during the QoS probe transaction window.

FIG. 5c illustrates one embodiment of a representative data structure of a master record 506. A typical master record 506 in one embodiment includes a total number of handles field 506a, a global transaction identifier field 506b, a latency value field 506c, a rate probe window field 506d, a QoS probe window field 506e, a service queue quantity field 506f, a rate probe identifier field 506g, a QoS probe identifier field 506h, a rate probe access link 506i, and a QoS probe access link 506j. The master record 506 may also be configured to store additional data for the dynamic service quality apparatus and method in general.

Some of the data stored in the master record 506 may be parametric as well as default information, such as the latency value stored in the latency value field 506c or the window values stored in the rate probe window field 506d and QoS probe window field 506e. Other information stored in the master record 506 may be dynamically modified during the implementation of the dynamic service quality process. For example, the number of materialized service queues 324 may change in response to a change in service quality and therefore the value stored in the service queue quantity field 506f may dynamically change.

The handle quantity field 506a preferably is a count of the total number of meta data resource handles 320 (LUNS or files) known to the server 302. The global transaction identifier field 506b preferably identifies the global transaction number currently in progress in the system, be it a QoS probe or a rate probe transaction. The latency value field 506cpreferably stores a default time value by which the I/O transactions of a selected resource handle 320 are delayed during a QoS probe assessment. The latency value field 506c is accessed, for example, when the optimization module 308 employs the latency alteration module 408. The rate probe window field 506d in one embodiment stores a default value designating the time duration of a typical rate probe assessment. Similarly, the QoS probe window field 506e stores a default value designating a time duration of a typical QoS probe assessment.

The service queue quantity field 506f preferably stores the quantity of currently materialized service queues 324. The rate probe identifier field 506g in one embodiment stores the sequential identifier for a subsequent rate probe assessment. Similarly, the QoS probe identifier field 506h stores the sequential identifier for a subsequent QoS probe assessment. The rate probe access link 506i preferably points to one or more rate probe transaction records 504 that correspond to the rate probe assessments that have occurred within a predetermined time frame, such as since system startup and initialization. Similarly, the QoS probe access link 506j preferably points to one or more QoS probe transaction records 504 that correspond to the QoS probe assessments that have occurred within a predetermined time frame. Both access links 506i and 506j provides a way for the assessment module 404 to access transaction history backwards in time during an assessment method.

FIG. 5d illustrates one embodiment of a representative data structure of a rate history record 508. A typical rate history record 508 may be created for each active resource handle 320 during a particular rate probe transaction window. The depicted rate history record 508 includes a rate probe identifier field 508a, a transaction type field 508b, a current service grade field 508c, and an I/O request count field 508d.

The rate probe identifier field 508a in one embodiment identifies the current rate probe transaction number. This rate probe transaction number corresponds to the rate probe transaction number stored in the rate probe identifier field 502a of the corresponding rate probe transaction record 502 and identifies the rate probe assessment during which the I/O request was observed. The transaction type field 508b stores and identification of the type of assessment, whether rate probe or QoS probe, during which the I/O request was observed. The current service grade field 508c preferably designates the current service grade associated with the selected resource handle 320 and assigned by an administrator or by the optimization module 308. The I/O request count field 508d preferably registers the quantity of I/O requests associated with a specific resource handle 320 during the rate probe assessment window.

FIG. 5e illustrates one embodiment of a representative data structure of a QoS tally record 510. A typical QoS tally record 510 may be created for each active resource handle 320 during a particular QoS probe assessment window. The depicted QoS tally record 510 includes a QoS probe identifier field 510a, a transaction type field 510b, a current service grade field 510c, and an I/O request count field 51d.

The QoS probe identifier field 510a preferably identifies the current QoS probe transaction number. This QoS probe transaction number corresponds to the QoS probe transaction number stored in the QoS probe identifier field 504a of the corresponding QoS probe transaction record 504 and identifies the QoS probe assessment during which the I/O request was observed. The transaction type field 51b stores and identification of the type of assessment, whether rate probe or QoS probe, during which the I/O request was observed. The current service grade field 510c designates the current service grade associated with the selected resource handle 320 and assigned during initialization of the system 302 or by the optimization module 308. The I/O request count field 510d preferably registers the quantity of I/O requests associated with a specific resource handle 320 during the QoS probe assessment window.

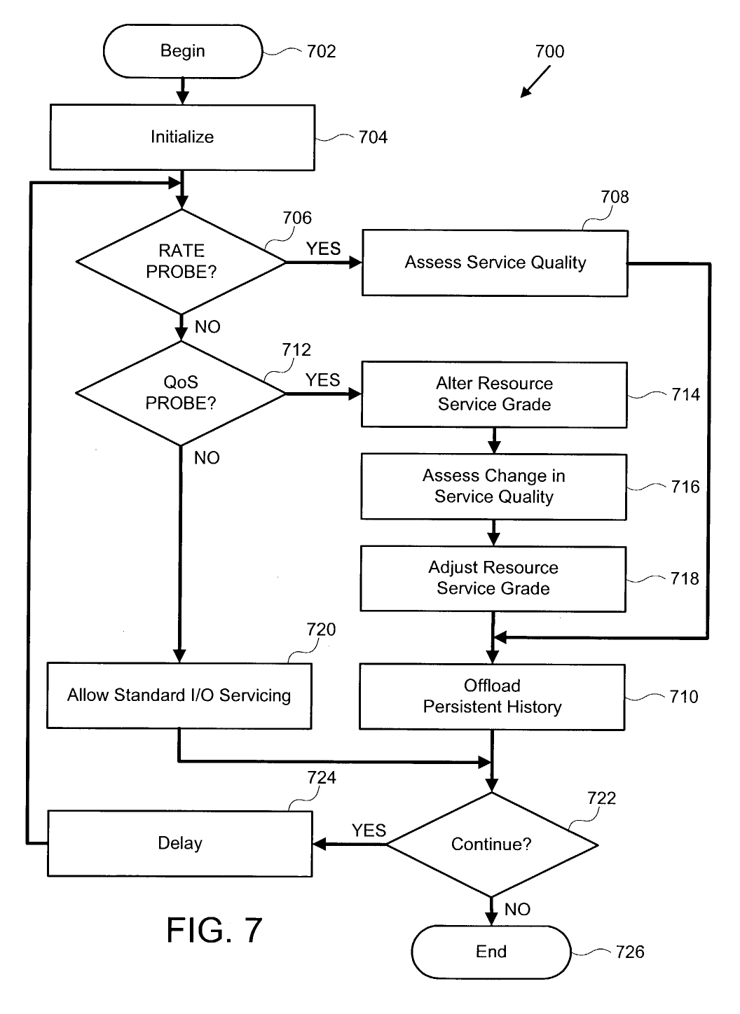

FIG. 6 illustrates one embodiment of the format of a resource handle 320. As stated previously, the resource handle 320 may be a file handle or a block LUN. The format of the handle 320 in the depicted embodiment includes a handle identity field 602, a selected service grade field 604, a modified service grade field 606, a rate history access link 608, a QoS tally access link 610, and at least one system information field 612 for required system information regarding the open handle instance and may incorporate a reference to other meta data associated with the available LUNs or files of the system 302.

The handle identity field 602 preferably contains an assigned resource handle identification for the selected resource handle. The selected service grade field 604 preferably designates the resource handle service grade assigned by the client 102. The modified service grade field 606 preferably designates the resource handle service grade assigned by the optimization module 308 after one or more QoS probe assessments. If the system 100 is in a rate probe assessment mode, the rate history access link 608 preferably points to the rate history record 508 for the current I/O transaction request. Similarly, if the system 100 is in a QoS probe assessment mode, the QoS tally access link 610 preferably points to the QoS tally record 510 for the current I/O transaction request.

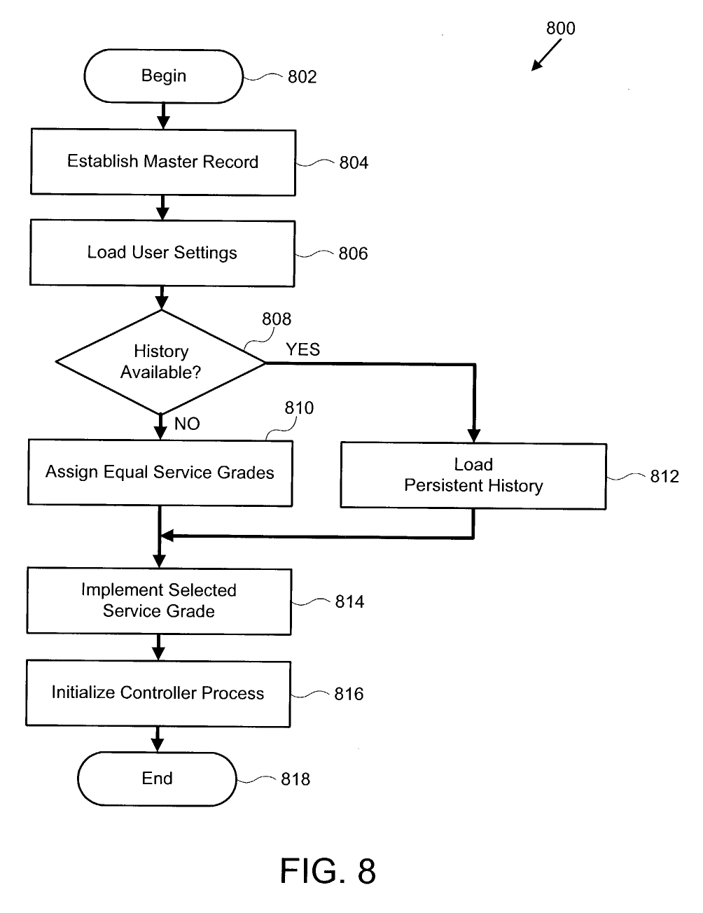

FIG. 7 illustrates one embodiment of a dynamic service quality method 700. The method 700 may be employed in a file serving system 100, a data storage subsystem 104, or in a separate application using similar techniques and modules. For simplification, any reference to the system 100 in the embodiments discussed below may be extended to the data storage sub-system 104, the data storage server 302, or any other appropriate application.

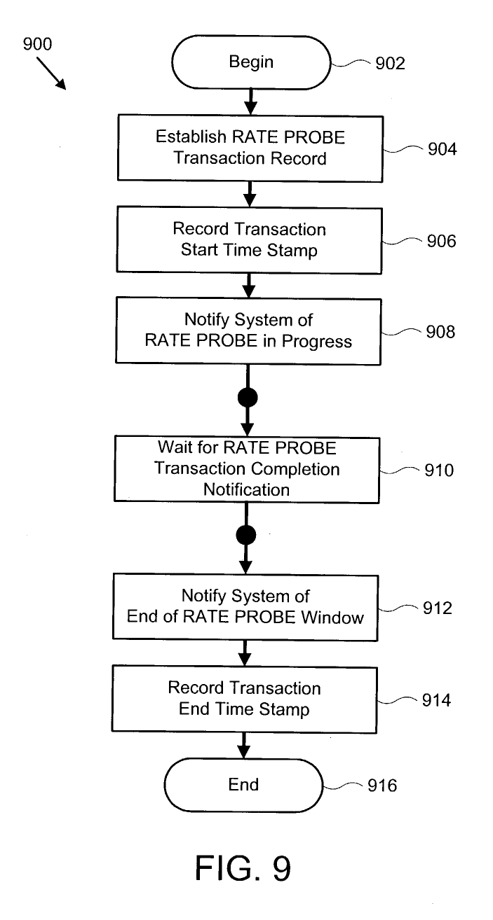

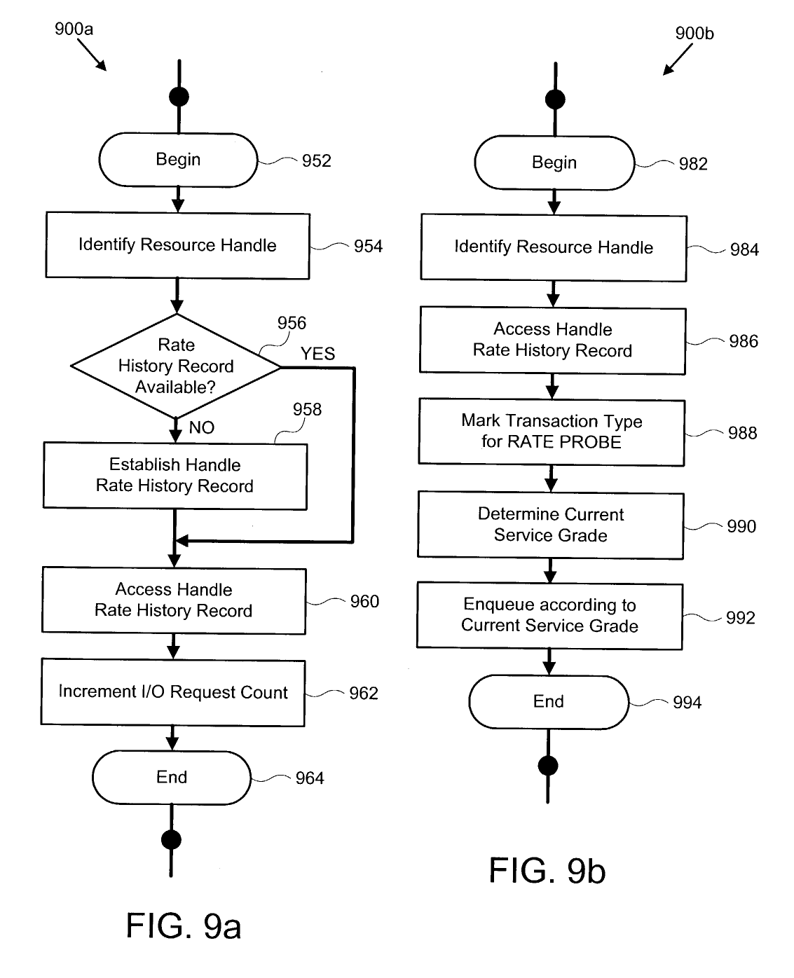

The method 700 begins 702 with system initialization 704, which will be discussed in more detail in conjunction with FIG. 8. The method 700 then proceeds with a determination 706 of whether to execute a rate probe. This determination 706 is executed for example by the selection module 422. If the system 100 determines 706 to execute a rate probe, the method 700 continues by assessing 708 the service quality of the system 100 under normal operating conditions. The service quality assessment 708 will be discussed in more detail in conjunction with FIGS. 9, 9a, and 9b. After assessing 708 the service quality of the system 100 under typical operating conditions, the method 700 allows any newly created rate probe transaction records 502 and rate history records 508 to be offloaded 710 from the local cache 306 to persistent electronic storage, such as the storage 110.

If the method 700 determines 706 not to execute a rate probe, the method 700 then proceeds with a determination 712 whether to execute a QoS probe. Typically, the method 700 will determine 706 to assess the service quality of the system 100 through execution of a sufficient number of rate probes prior to the execution of any QoS probes. In one embodiment, one rate probe cycle may be sufficient. If the method 700 determines 712 to execute a QoS probe, it alters 714 the service grade of a selected resource handle 320, assesses 716 a change in the service quality of the system 100, and adjusts 718 the service grade of the selected resource handle 320 in response to the modified service quality of the system 100. After executing a QoS probe, the method 700 allows any newly created QoS probe transaction records 504 and QoS tally records 510 to be offloaded 710 to persistent storage. In one embodiment, whether records are offloaded to persistent storage may depend on the capacity of the electronic storage device 306.

If, on the other hand, the method 700 determines 712 not to execute a QoS probe, the system 100 enters a “no probe” state, which allows 720 standard I/O servicing of all transactions. During a “no probe” state, the system 100 does not create or modify any of the records discussed in FIG. 5. Rather, the system 100 processes the I/O read and write requests normally without any alteration or intervention by the optimization module 308.

After completion of a “no probe” state, or after offloading 710 any available records 502, 504, 508, 510, the method 700 tests 722 for continuation of the rate probe, QoS probe, and “no probe” steps. The method 700 either repeats the probe determinations 706, 712 or the method 700 ends 724. Prior to repeating, the method 700 may delay 724 further action for a predetermined amount of time during which the system may operate under standard conditions. In one embodiment, the delay 724 period may be set to zero by a user so as to continuously cycle through probes. Alternately, the delay 724 period may be contingent on one or more system parameters.

In one embodiment, the method 700 begins with the startup of the system 100 and continuously loops until the system 100 is shut down, at which time, of course, the method ends 724. In an alternate embodiment, the method 700 may be implemented randomly or at set intervals to consistently and dynamically update and maintain a service quality within the system 100. In general, the method 700 may be implemented in the storage sub-system 104 and carried out in a manner that is transparent to the client 102.

FIG. 8 illustrates one embodiment of an initialization method 800 given by way of example of the initialization step 704 of FIG. 7. The depicted method 800 begins 802 by establishing 804 a master record 506, preferably of the format explained in the description of FIG. 5c, and loads 806 any appropriate user settings supplied by the client 102. The method 800 may then determine 808 if a previously created records 502, 504, 508, 510 are stored in permanent electronic storage 110. If such records 502, 504, 508, 510 are not available, the method 800 assigns 810 the same service grade to all open resource handles 320 for normal processing. If such records 502, 504, 508, 510 are available, the method 800 loads 812 the available records 502, 504, 508, 510 for use by the system 100.

If the client 102 provides an alternate selected service grade for a specific resource handle 320, the method 800 implements 814 the selected service grade for that resource handle 320 before the method 800 initializes 816 an entity/daemon controller to oversee the remaining steps of the method 700. The entity/daemon controller is in one embodiment located on the storage device 306 within the resource management module 304. The method 800 then ends 818.

FIG. 9 illustrates one embodiment of a service quality assessment method 900 given by way of example of an assessment step 708 of FIG. 7. The depicted service quality assessment method 900 is preferably carried out via a controller process. The method 900 begins 902 by establishing 904 a new rate probe transaction record 502 for the current rate probe assessment and records 906 the rate probe transaction start time stamp in the start time stamp field 502b of the rate probe transaction record 502. The method 900 continues with the entity/daemon controller notifying 908 the system 100 that a rate probe is in progress. As part of such notification 910, the controller registers a timer for an end-of-rate-probe-transaction notification. The controller then processes the I/O transactions of all active resource handles 320 while it waits 910 for notification of completion of the rate probe window. The rate probe window duration may be specified in the rate probe window field 506d of the master record 506. FIGS. 9a and 9b provide further detail as to the I/O and receiver processes, respectively, that occur during the rate probe window.

Upon receipt of the rate probe transaction completion notification, the method 900 notifies 912 the system 100 that the rate probe window has ended and records 914 the transaction end time stamp in the end time stamp field 502c of the rate probe transaction record 502. The method 900 then ends 918.

FIG. 9a depicts the I/O process 900a that occurs in parallel with the controller process while the service quality assessment method 900 waits 910 for notification of the completion of the rate probe window. The I/O process 900a begins 952 with the receipt of an I/O transaction during the rate probe window. The I/O process 900a identifies 954 the resource handle 320 for which the transaction has been requested. The I/O process 900a then determines 956 if an existing rate history record 508 has been created for the identified resource handle 320 during the current rate probe window. If a rate history record 508 does not exist, the I/O process 900a establishes 958 the necessary record 508.

If a corresponding rate history record 508 already exists, or after a new rate history record 508 is established 958, the record 508 is accessed 960. The I/O process 900a specifically increments 962 the I/O request count stored in the I/O request count field 508d of the rate history record 508 for the identified resource handle 320. The process 900a then ends 964. This I/O process 900a is executed each time a transaction request arrives at the storage server 302 during a rate probe window. In essence, the I/O process 900a in the described embodiment counts the number of I/O transaction requests for each active resource handle 320 during the rate probe window.

FIG. 9b depicts the receiver process 900b that also occurs in parallel with the controller process while the service quality assessment method 900 waits 910 for notification for the completion of the rate probe window. For each I/O request received during the rate probe window, the receiver process 900b begins 982 by identifying 984 the resource handle 320 for which the transaction has been requested. The receiver process 900b then accesses 986 the rate history record 508 for the identified resource handle 320 and marks 988 the transaction type in the transaction type field 508b. From the current service grade field 508c of the rate history record 508, the receiver process 900b determines 990 the current service grade of the identified resource handle 320. The receiver process 900b then enqueues 992 the I/O transaction request in the proper service priority queue 324 for processing. Then the receiver process 900b ends 994.

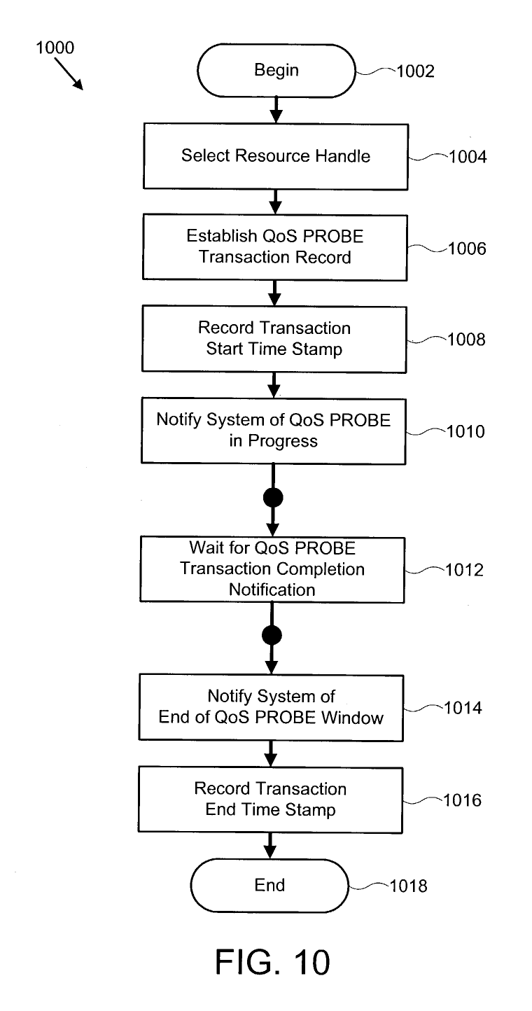

FIG. 10 illustrates one embodiment of a service grade alteration method 1000 given by way of example of an alteration step 714 of FIG. 7. The depicted service grade alteration method 1000 is carried out via a controller process. The method 1000 begins 1002 by randomly selecting 1004 a candidate resource handle 320 from a list of active resource handles 320. The selection 1004 in one embodiment may be implement pseudo-random algorithm that prohibits a single resource handle 320 from being selected 1004 for sequentially adjacent probe cycles. The method attempts to not repeatedly choose the same candidate resource handle by recording the selected handle to the QoS probe transaction record 504 in the field 504f.

The method 1000 then establishes 1006 a QoS probe transaction record 504 and records 1008 the QoS probe transaction start time stamp in the start time stamp field 504b of the QoS probe transaction record 504. The method 1000 continues with the entity/daemon controller notifying 1010 the system 100 that a QoS probe is in progress. As part of such notification 1010, the controller registers a timer for an end-of-QoS-probe-transaction notification. The controller then processes the I/O transactions of all active resource handles 320 while it waits 1012 for notification of completion of the QoS probe window. The QoS probe window duration may be specified in the QoS probe window field 506e of the master record 506. FIGS. 10a and 10b provide further detail as to the I/O and receiver processes, respectively, that occur during the QoS probe window.

Upon receipt of the QoS probe transaction completion notification, the method 1000 notifies 1014 the system 100 that the QoS probe window has ended and records 1016 the transaction end time stamp in the end time stamp field 504c of the QoS probe transaction record 504. The method 1000 then ends 1018.

FIG. 10a depicts the I/O process 1000a that occurs in parallel with the controller process while the service grade alteration method 1000 waits 1012 for notification of the completion of the QoS probe window. The I/O process 1000a begins 1052 with the receipt of an I/O transaction during the QoS probe window. The I/O process 1000a identifies 1054 the resource handle 320 for which the transaction has been requested. The I/O process 1000a then determines 1056 if the identified resource handle 320 is the same as the resource handle 320 selected 1004 for alteration. If the identified resource handle 320 is the same as the selected 1004 resource handle 320, then the I/O process 1000a adds 1058 a predetermined amount of latency to the I/O transaction request. The specific amount of latency to be added 1058 may be specified in the latency value field 506c of the master record 506, which may be purely parametric to the system. Alternately, if the identified resource handle 320 is not the candidate resource handle 320 selected 1004 for alteration, then no latency is added to the transaction request. The I/O process 1000a then determines 1060 if an existing QoS tally record 510 has been created for the identified resource handle 320 during the current QoS probe window. If a QoS tally record 510 does not exist, the I/O process 1000a establishes 1062 the necessary record 510.

If a corresponding QoS tally record 510 already exists, or after a new QoS tally record 510 is established 1062, the record 510 is accessed 1064. The I/O process 1000a specifically increments 1066 the I/O request count stored in the I/O request count field 510d of the QoS tally record 510 for the identified resource handle 320. The process 1000a then ends 1068. This I/O process 1000a is executed each time a transaction request arrives at the storage server 302 during a QoS probe window. In essence, the I/O process 1000a in the described embodiment counts the number of I/O transaction requests for each active resource handle 320 during the QoS probe window.

FIG. 10b depicts the receiver process 1000b that also occurs in parallel with the controller process while the service grade adjustment method 1000 waits 1012 for notification for the completion of the QoS probe window. For each I/O request received during the QoS probe window, the receiver process 1000b begins 1082 by identifying 1084 the resource handle 320 for which the transaction has been requested. The receiver process 1000b then accesses 1086 the QoS tally record 510 for the identified resource handle 320 and marks 1088 the transaction type in the transaction type field 510b. From the current service grade field 510c of the QoS tally record 510, the receiver process 1000b determines 1090 the current service grade of the identified resource handle 320. The receiver process 1000b then enqueues 1092 the I/O transaction request in the proper service priority queue 324 for processing. Then the receiver process 1000b ends 1094.

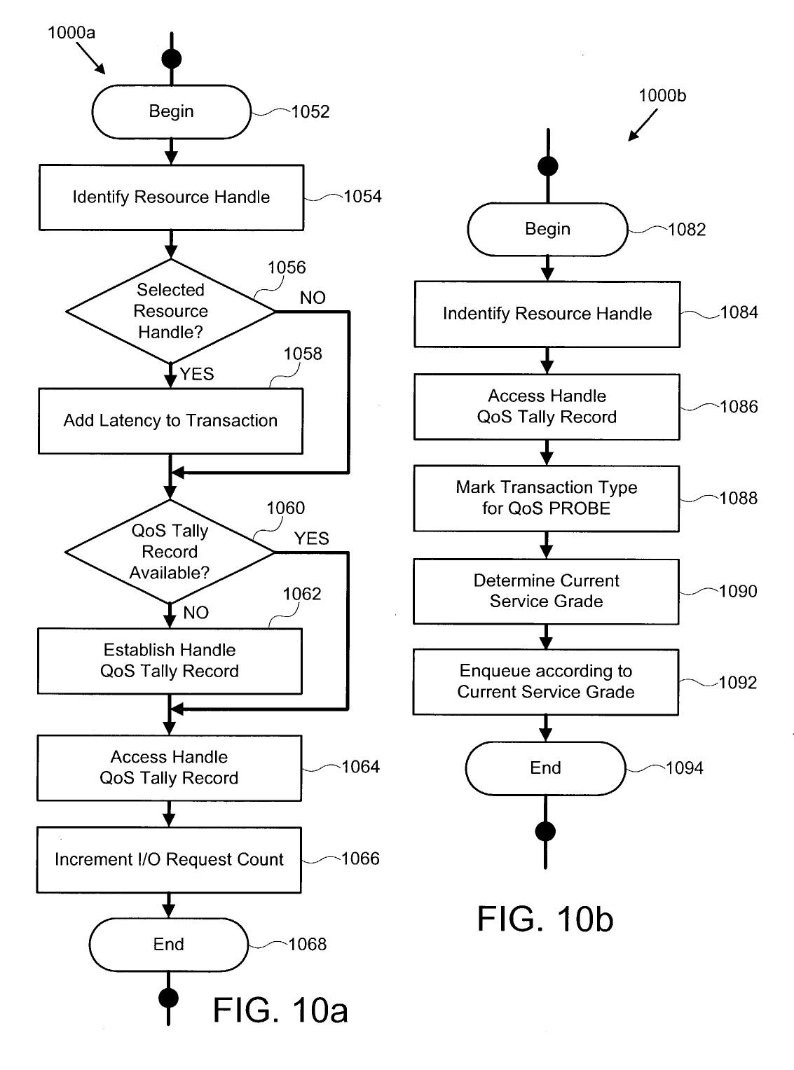

FIG. 11 illustrates one embodiment of a service quality change assessment method 1100 given by way of example of an assessment step 716 of FIG. 7. The method 1100 begins 1102 by accessing 1104 a master record 506, accessing 1106 a rate probe transaction record 502, and accessing 1108 a QoS probe transaction record 504. Using the information from the records 502, 504, 506, the controller process compares 1110 the rate history record 508 statistics to the QoS tally record 510 statistics for all of the I/O transaction requests of the active resource handles 320. In this way, the controller process may determine the net impact on the system 100 of the artificial latency added 1058 in the I/O process 1000a of the service grade alteration method 1000.

The controller process may further determine 1112 a new service grade for the selected 1004 resource handle 320 depending on the impact the altered I/O processing might have had. For example, if intentionally delaying 1058 the I/O transaction requests associated with the candidate resource handle 320 selected 1004 decreased overall performance of the system 100 as measured through lower arrival rates of all active resource handles 320, the method 1100 may determine 1112 that the resource handle should be assigned a new service grade of higher priority than its current rank. Conversely, if adding 1058 latency to the transactions of the candidate resource handle 320 allowed for better arrival rates overall, the method 1100 may determine 1112 that the candidate resource handle 320 should be assigned a new service grade of lower priority. If this step is indecisive, the service grade may be left unchanged. The method 1100 then ends 1114.

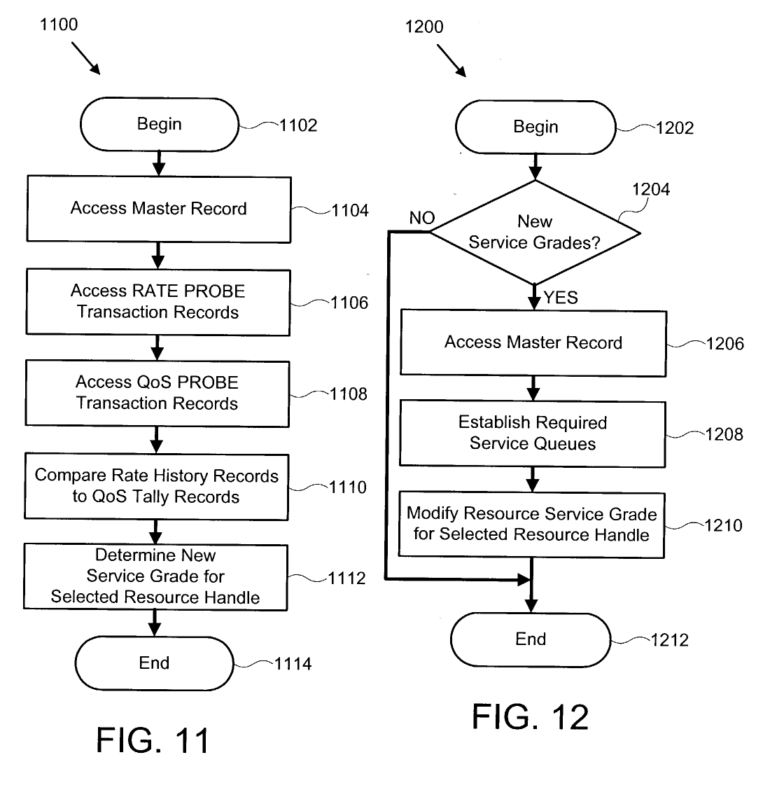

FIG. 12 illustrates one embodiment of a service grade adjustment method 1200 given by way of example of an adjustment step 718 of FIG. 7. The method begins 1202 by determining 1204 if new service grades have been assigned to one or more active resource handles 320. If new service grades have been assigned to increase system performance, the method 1200 accesses 1206 the master record 506 to recall any necessary information regarding the comparison performed in conjunction with the assessment method 1100. As mentioned above, the master record 506 also contains links to the rate probe transaction records 502 and QoS probe transaction records 502, which in turn have links to the rate history records 508 and QoS tally records 510, respectively.

Using the information from the master record 506, the entity/daemon controller establishes 1208 the required number of request processing queues 324 depending on the total number of employed service grades and priority queue schemes that may exist within the system 100. The manner of materializing and dematerializing processing queues 324 may be implemented as currently known in the art or in any other appropriate manner. The method 1200 continues by modifying 1210 the service grade of the selected 1004 resource handle 320. After the method 1200 modifies 1210 the service grade of the resource handle 320, or if the method 1200 determines 1204 that no new service grades have been assigned, the service grade adjustment method 1200 ends 1212.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for improving service quality within a data storage system, the method comprising:
altering a service grade associated with a selected resource handle;
assessing a change in service quality for the data storage system; and
adjusting the service grade for the selected resource handle in response to the change in service quality.

2. The method of claim 1, wherein altering the service grade comprises altering a service latency.

3. The method of claim 1, wherein altering the service grade comprises altering a service priority.

4. The method of claim 1, wherein assessing the change in service quality comprises computing an arrival rate for an active resource handle in the data storage system.

5. The method of claim 1, wherein adjusting the service grade comprises adjusting a service priority.

6. The method of claim 1, wherein the selected resource handle comprises a file handle.

7. The method of claim 1, wherein the selected resource handle comprises a block logical unit number (LUN).

8. The method of claim 1, further comprising providing a service queue corresponding to the service grade.

9. The method of claim 1, further comprising initializing the service grade to a selected grade, and initializing the service grade to a default grade if the selected grade is unavailable.

10. The method of claim 1, wherein improving service quality within a data storage system is conducted in a manner that is transparent to a host.

11. A method for improving service quality within a data storage system that is connected to a host, wherein the method is conducted in a manner that is transparent to the host, the method comprising:
altering a service grade associated with a selected resource handle;
assessing a change in service quality for the data storage system;
adjusting the service grade for the selected resource handle in response to the change in service quality;
providing a service queue corresponding to the service grade; and
initializing the service grade to a selected grade, and initializing the service grade to a default grade if the selected grade is unavailable.

12. An apparatus for improving service quality within a data storage system, the apparatus comprising:
an alteration module configured to alter a service grade associated with a selected resource handle;
an assessment module configured to assess a change in service quality for the data storage system; and
an adjustment module configured to adjust the service grade for the selected resource handle in response to the change in service quality.

13. The apparatus of claim 12, further comprising a latency alteration module configured to alter a service latency.

14. The apparatus of claim 12, further comprising a priority alteration module configured to alter a service priority.

15. The apparatus of claim 12, further comprising an arrival rate module configured to compute an arrival rate for an active resource handle in for the data storage system.

16. The apparatus of claim 12, further comprising a priority adjustment module configured to adjust a service priority.

17. The apparatus of claim 12, wherein the selected resource handle comprises a file handle.

18. The apparatus of claim 12, wherein the selected resource handle comprises a block logical unit number (LUN).

19. The apparatus of claim 12, further comprising a service queue module configured to provide a service queue corresponding to the service grade.

20. The apparatus of claim 12, further comprising an initialization module configured to initialize the service grade to a selected grade, and to initialize the service grade to a default grade if the selected grade is unavailable.

21. The apparatus of claim 12, wherein improving service quality within a data storage system is conducted in a manner that is transparent to a host.

22. An apparatus for improving service quality within a data storage system and conducted in a manner that is transparent to a host, the apparatus comprising:
an alteration module configured to alter a service grade associated with a selected resource handle;
an assessment module configured to assess a change in service quality for the data storage system;
an adjustment module configured to adjust the service grade for the selected resource handle in response to the change in service quality;
a service queue module configured to provide a service queue corresponding to the service grade;
an initialization module configured to initialize the service grade to a selected grade, and to initialize the service grade to a default grade if the selected grade is unavailable

23. A system for improving service quality within a data storage system, the system comprising:
a data storage subsystem;
an optimization module configured to improve service quality within the data storage sub-system, the optimization module comprising:
an alteration module configured to alter a service grade associated with a selected resource handle;
an assessment module configured to assess a change in service quality for the data storage system; and
an adjustment module configured to adjust the service grade for the selected resource handle in response to the change in service quality; and
a network configured to provide a communications means between the data storage sub-system and a client.

24. A data storage sub-system for improving performance of resource handle transactions within a network data storage sub-system, the data storage sub-system comprising:
a service queue module configured to provide a service queue and to queue the resource handle transactions;
an optimization module configured to adjust a service priority associated with a resource handle within the data storage sub-system;
the optimization module further configured to assess a change in service quality for the data storage sub-system; and
the service queue module further configured to direct the resource handle transactions to the service queue.

25. A computer readable medium comprising computer code configured to carry out a method for improving service quality within a data storage system, the method comprising:
altering a service grade associated with a selected resource handle;
assessing a change in service quality for the data storage system;
adjusting the service grade for the selected resource handle in response to the change in service quality;

26. The computer readable medium of claim 25, wherein altering the service grade comprises altering a service latency.

27. The computer readable medium of claim 25, wherein altering the service grade comprises altering a service priority.

28. The computer readable medium of claim 25, wherein assessing the change in service quality comprises computing an arrival rate for an active resource handle in the data storage system.

29. The computer readable medium of claim 25, wherein adjusting the service grade comprises adjusting a service priority.

30. The computer readable medium of claim 25, wherein the selected resource handle comprises a file handle.

31. The computer readable medium of claim 25, wherein the selected resource handle comprises a block logical unit number (LUN).

32. The computer readable medium of claim 25, wherein the method further comprises providing a service queue corresponding to the service grade.

33. The computer readable medium of claim 25, wherein the method further comprises initializing the service grade to a selected grade, and initializing the service grade to a default grade if the selected grade is unavailable.

34. The computer readable medium of claim 25, wherein the method is conducted in a manner that is transparent to a host.

35. An apparatus for improving service quality within a data storage system and conducted in a manner that is transparent to a host, the apparatus comprising:
means for altering a service grade associated with a selected resource handle;
means for assessing a change in service quality for the data storage system;
means for adjusting the service grade for the selected resource handle in response to the change in service quality;
means for providing a service queue corresponding to the service grade; and
means for initializing the service grade to a selected grade, and initializing the service grade to a default grade if the selected grade is unavailable.
